(19) United States
(12) Patent Application Publication
(10) Pub. No.: US 2011/0243227 A1
(43) Pub. Date: Oct. 6, 2011

(54) MOVING PICTURE DECODING METHOD AND DEVICE, AND MOVING PICTURE ENCODING METHOD AND DEVICE

(75) Inventors: Kenichi Yoneji, Kodaira (JP); Masashi Takahashi, Tachikawa (JP)

(73) Assignee: HITACHI, LTD., Tokyo (JP)

(21) Appl. No.: 13/133,390

(22) PCT Filed: Nov. 30, 2009
(86) PCT No.: PCT/JP2009/006476

§ 371 Date: Jun. 8, 2011

(30) Foreign Application Priority Data
Dec. 10, 2008 (JP) 2008-313879

(51) Int. Cl. H04N 7/32

(52) U.S. Cl. 375/240.12; 375/E07.243

(57) ABSTRACT

The objective is to reduce the amount of code in the encoding/decoding process for a moving picture. In an intra prediction process, the degree of ease of estimating the prediction direction or the block mode for a block to be decoded is determined based on the prediction direction data or the block mode for multiple adjacent blocks which have been decoded previously and which are adjacent to the block to be decoded; the prediction direction data or the block mode for the block to be decoded is decoded based on the result of said determination; and intra prediction is performed based on the decoded prediction direction data or the block mode to generate decoded image data.

### TECHNICAL FIELD

The present invention relates to a moving picture encoding technique for encoding a moving picture, and a moving picture decoding technique for decoding a moving picture.

### BACKGROUND ART

An encoding system such as an MPEG (Moving Picture Experts Group) system or the like has been designed as a technique for bringing a large capacity of moving picture information into digital data and recording and transmitting the same. There have been known MPEG-1, MPEG-2, MPEG-4 and H.264/AVC (Advanced Video Coding) standards, and so on.

In H.264/AVC, the efficiency of compression has been improved by using prediction encoding such as intra prediction encoding, inter prediction encoding or the like. At this time, various directions exist in the prediction encoding. They are used properly in block units for the purpose of their encoding. At this time, a problem arose in that codes each indicative of a prediction direction used in a target block needed to be encoded separately, thus increasing the amount of coding.

Since prediction was performed every macro block while performing switching between a plurality of pixel value prediction methods and block sizes upon each prediction encoding, it was necessary to encode information on the pixel value prediction methods and block sizes for every macro block.

For this problem, there has been disclosed in, for example, a Non Patent Literature 1 that upon encoding of each prediction direction at intra prediction encoding, a code for representing the prediction direction is made short with respect to each block at the edge of an image, small in the available number of prediction directions, thereby reducing the amount of coding.

### CITATION LIST

### Non Patent Lierature

Non Patent Literature 1: Jamil-ur-Rehman and Zhang Ye, “Efficient Techniques for Signalling Intra Prediction Modes of H.264/Mpeg-4 Part 10”, Proc. ICICIC2006, August, 2006.

### SUMMARY OF INVENTION

### Technical Problem

The technique described in the Non Patent Literature 1 is, however, applicable to only each block at the edge of the image, but has a problem in that the effect of improving the efficiency of compression is small.

The present invention has been made in view of the above problems. An object of the present invention is to more reduce the amount of coding in an encoding/decoding process of a moving picture.

### Solution to Problem

In order to address the above problems, one embodiment of the present invention may be configured as described in Claims, for example.

### Advantageous Effects of Invention

The amount of coding can be more reduced in an encoding/decoding process of a moving picture.

### BRIEF DESCRIPTION OF DRAWINGS

FIG. 1 is one example of a block diagram of an image encoding device according to an embodiment 1.

FIG. 2 is one example of a block diagram of an intra prediction encoding device according to the embodiment 1.

FIG. 3 is one example of a block diagram of an image decoding device according to the embodiment 1.

FIG. 4 is one example of a block diagram of an intra prediction decoding device according to the embodiment 1.

FIG. 5 is a conceptual explanatory diagram of an intra prediction encoding process according to H.264/AVC.

FIG. 6 is a conceptual explanatory diagram of an encoding process of each prediction direction according to H.264/AVC.

FIG. 7 is a conceptual explanatory diagram of an intra prediction decoding process according to H.264/AVC.

FIG. 8 is an explanatory diagram of one example of prediction direction encoding according to the embodiment 1.

FIG. 9 is a flowchart of the image encoding device according to the embodiment 1.

FIG. 10 is a flowchart of the intra encoding device according to the embodiment 1.

FIG. 11 is a flowchart of the image decoding device according to the embodiment 1.

FIG. 12 is a flowchart of the intra decoding device according to the embodiment 1.

FIG. 13 is a conceptual explanatory diagram of a prediction encoding process used in H.264/AVC.

FIG. 14 is an explanatory diagram of an embodiment related to the encoding of block type according to an embodiment 2.

FIG. 15 is a block diagram of a variable length coding device according to the embodiment 2.

FIG. 16 is a block diagram of a variable length decoding device according to the embodiment 2.

FIG. 17 is a flowchart of the variable length coding device according to the embodiment 2.

FIG. 18 is a flowchart of the variable length decoding device according to the embodiment 2.

### DESCRIPTION OF EMBODIMENTS

Embodiments of the present invention will hereinafter be explained with reference to the accompanying drawings.

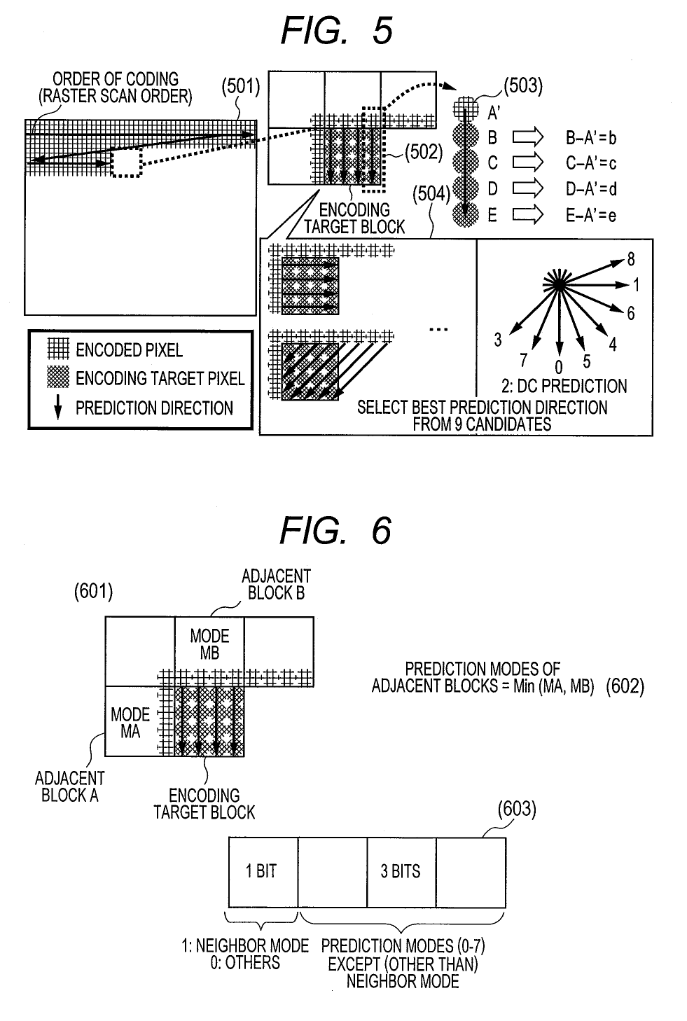

FIG. 5 conceptually shows the operation of an intra prediction encoding process based on H.264/AVC.

In H.264/AVC, an encoding process is performed to a target frame for encoding in accordance with raster scan order (501). A prediction process is performed using a decoded image with respect to encoded blocks adjacent to the left, upper left, upper part and upper right of a target block for encoding. The prediction process utilizes pixel values of 13 pixels included in each encoded block (502). Pixels on the same straight line with a prediction direction vector as a gradient or tilt are all predicted based on the same pixel. As designated at (503), for example, pixels B, C, D and E of a target block for encoding are all subjected to prediction encoding processing referring to the same pixel. Differences (residuals) b, c, d and e between the pixels B, C, D and E of the target block and a value A′ obtained by decoding a pixel directly above the pixel B are first calculated. Next, one prediction direction is selected in block units out of candidates of prediction direction of eight types such as vertical, horizontal and diagonal directions. The residuals and a prediction direction value indicative of the selected one prediction direction are encoded. In H.264/AVC, however, “DC prediction” for predicting all pixels included in the target block for encoding by an average value of reference pixels can be used in addition to the prediction process along the specific prediction direction (504).

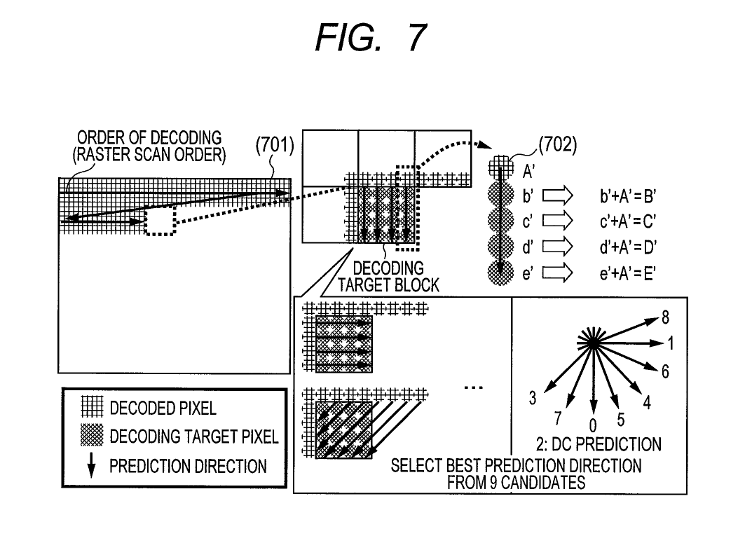

FIG. 7 conceptually shows the operation of an intra prediction decoding process by H.264/AVC.

The decoding process is also performed in accordance with raster scan order in a manner similar to the encoding process (701). Next, an inverse procedure of the encoding process is performed using the decoded referenced pixel and the residual. That is, residual values and a reference pixel value are added along the prediction direction to thereby obtain a decoded image. For example, reference numeral (702) indicates the process of adding a decoded reference pixel A′ to residuals b′, c′, d′, and e′ (those in which b, c, d, and e of FIG. 5 are decoded and which include quantization errors, respectively) of a target block for decoding to thereby obtain encoded pixels B′, C′, D′, and E′ (decoded pixels for B, C, D, and E of FIG. 5 respectively).

As described above, the intra prediction encoding process based on H.264/AVC adopts a unidirectional method for predicting pixels located along the prediction direction from the reference pixel, based on the reference pixel. In this case, it was necessary to add information as to along which prediction direction should be used for prediction process of every block taken as the unit of the prediction process, to an encoded video stream.

FIG. 6 shows a method of encoding a prediction direction in an intra prediction system based on H.264/AVC.

H.264/AVC pays attention to the fact that a prediction direction of a target block is in high correlation with a prediction direction of an adjacent block and estimates a prediction direction of a target block for encoding from prediction directions of encoded adjacent blocks. That is, as designated at reference numeral (601), reference is made to a prediction direction of a block A adjacent to the left side of a target block for encoding, and a prediction direction of a block B adjacent to the upper side of the target block identically. The prediction direction small in prediction direction value, of the two prediction directions is assumed to be a predicted value (adjacent direction) of the prediction direction of the target block (602).

Reference numeral (603) designates the details of a bit pattern indicative of a prediction method. In H.264/AVC, when the prediction direction for the target block and the prediction direction for the adjacent block are the same, information (1 bit) is encoded which indicates that the prediction direction for the target block and the prediction direction for the adjacent block correspond to the same prediction direction.

On the other hand, when both are different from each other, information is encoded which indicates that the prediction direction for the target block and the prediction direction for the adjacent block are different from each other. Thereafter, actual prediction directions (eight types excepting the prediction direction for each adjacent block, of eight directions+nine types of prediction directions related to DC prediction) are encoded in 3 bits.

In this case, a large number of codes are required to represent each prediction direction. When intra prediction is performed in block units of a 4×4 pixel size, for example, a code of 64 bits is generated per macro block at maximum.

### Embodiment 1

The embodiment 1 is an example in which the present invention is used in an encoding process for a prediction direction of a target block and a decoding process therefor upon intra prediction. In the present embodiment, it is determined whether it is easy to estimate the prediction direction of the target block, using prediction direction data of each block adjacent to the target block. The encoding and decoding methods of the prediction direction data on the target block are switched between the case where it is determined that it is easy to estimate the prediction direction of the target block and the case where it is determined that it is not easy to estimate the prediction direction of the target block.

The present embodiment will hereinafter be described in further detail.

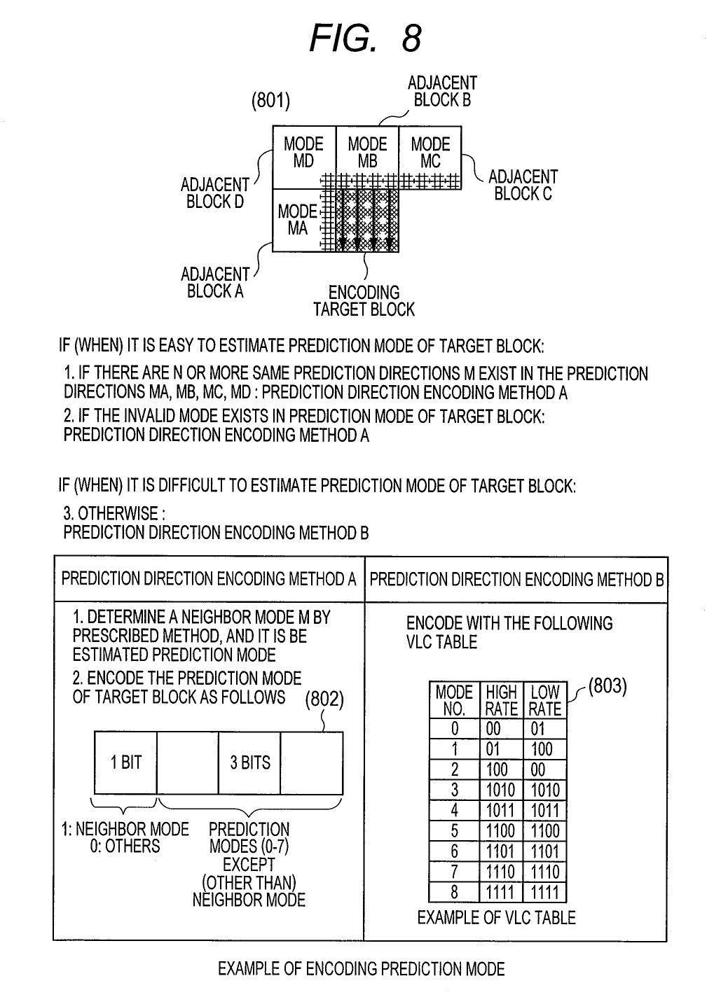

FIG. 8 is a diagram showing one example of a method for determining whether it is easy to estimate a prediction direction of a target block for encoding, and a prediction direction encoding method A and a prediction direction encoding method B. The method of determining whether it is easy to estimate the prediction direction of the target block for encoding will be explained using FIG. 8.

As shown in an image block explanatory diagram (801), prediction directions MA, MB, MC and MD of encoded adjacent blocks A, B, C and D adjacent to the left, upper, upper left and upper right sides of the target block are used in determining whether it is easy to estimate the prediction direction of the target block. That is, when there are N (where N: integers greater than or equal to 2 and less than or equal to 4) or more same prediction directions M exist in the prediction directions MA, MB, MC and MD, the estimation of the prediction direction of the target block is determined to be easy, and prediction direction data of the target block is encoded using the prediction direction encoding method A.

When prediction direction information about each adjacent block cannot be utilized as the prediction direction of the target block as in the case of the existence of the target block in the edge of a slice, the edge of an image, and the like, for example, it is determined that it is easy to estimate the prediction direction of the target block, and prediction direction data of the target block is encoded using the prediction direction encoding method A.

Incidentally, as to the blocks that do not correspond even to both of the above cases, the estimation of the prediction direction is determined not to be easy, and the prediction direction encoding method B (803) is selected to perform variable length encoding.

When the prediction direction encoding method A is selected by the above determination method, it proceeds to a prediction direction selection process. That is, any of the prediction directions MA, MB, MC and MD of the encoded adjacent blocks A, B, C and D adjacent to the left, upper, upper left and upper right sides of the target block for encoding is selected by a prescribed method. The prediction direction of the selected adjacent block is assumed to be an estimated prediction direction of the target block.

Now, while the prescribed selection method may be any selection method if there is provided a method capable of achieving a similar process at both of the encoding and decoding sides, for example, a method of selecting the smallest prediction direction in prediction direction value out of MA, MB, MC and MC, a method of selecting the most prediction direction value of MA, MB, MC and MD, etc. may be used.

Further, as to the encoding process where the prediction direction encoding method A is selected, the encoded adjacent blocks A, B, C and D adjacent to the left, upper, upper left and upper right sides of the target block for encoding may be used as adjacent blocks to perform the encoding process. Alternatively, only the encoded adjacent blocks A and B adjacent to the left and right sides of the target block may be used as adjacent blocks as is usual to perform the encoding process.

The prediction direction encoding method A will next be explained in further detail. The prediction direction encoding method A is a method for determining estimated prediction information using prediction direction information about each adjacent block and encoding prediction direction data of the target block using the estimated prediction information.

A bit pattern diagram (802) of FIG. 8 is a diagram showing the details of a bit pattern for encoding of the prediction direction data of the target block in the prediction direction encoding method A.

When the prediction direction for the target block for encoding and the prediction direction (estimated prediction direction) for each adjacent block are the same direction, information (1 bit) indicating that the prediction direction for the target block and the prediction direction (estimated prediction direction) for the adjacent block are the same direction, is encoded.

On the other hand, when the prediction direction for the target block is different from the prediction direction (estimated prediction direction) for the adjacent block, information indicating that the prediction direction for the target block and the prediction direction (estimated prediction direction) for the adjacent block are different from each other is encoded. Thereafter, actual prediction directions (eight types excluding the prediction direction of adjacent block (estimated prediction direction), which are out of nine types of prediction directions that consist of eight directions+DC prediction) are encoded in 3 bits.

The prediction direction encoding method B will next be explained in further detail. The prediction direction encoding method B is a method for independently encoding prediction direction data of the target block without estimating the prediction direction data of the target block, based on prediction direction data of each adjacent block.

The table (803) of FIG. 8 is one example of a variable length coding table used in the prediction direction encoding method B. The prediction direction encoding method B variable-length encodes the prediction direction data of the target block for encoding in accordance with such a variable length coding table as shown in the table (803). When the variable length table like the table (803) is used, there is no mode which can be expressed in only 1 bit as in the case of the prediction direction encoding method A, but some modes can be expressed in 2 or 3 bits smaller than 4 bits even in prediction directions different from adjacent modes. Thus, in the prediction direction encoding method B, the number of modes that can be expressed in the bits smaller than 4 bits is greater than that in the prediction direction encoding method A. Now, when the prediction direction encoding method B is used in the present embodiment, it shows the case where the prediction direction of the target block is determined not to be easy as described above in the first place. This therefore corresponds to where there is a low probability of the prediction direction of the target block coinciding with the prediction direction of each adjacent block. That is, in this case, if the prediction direction encoding method A is used, the probability that the amount of coding in the prediction direction will be 4 bits is higher than the probability that the amount of coding in the prediction direction will be one bit. Thus, in such a case, an improvement in the probability that the prediction direction will be encoded with the amount of coding of 2 or 3 bits, by using the prediction direction encoding method B is effective in reducing the amount of coding. Incidentally, the variable length coding table corresponding to the table (803) is one example, and other patterns may be adopted if similar advantageous effects are obtained.

While the encoding process according to the present embodiment has been explained above, the decoding process can be performed by carrying out a process opposite to the corresponding encoding method upon the decoding process. That is, the decoding process according to the present embodiment determines using prediction direction information of adjacent decoded blocks whether it is easy to estimate a prediction direction of a target block for decoding. When it is determined that it is easy to estimate the prediction direction of the target block, prediction direction data about the target block for decoding is decoded in accordance with the bit pattern shown in the bit pattern (802). On the other hand, when the estimation of the prediction direction of the target block is determined not to be easy, prediction direction data about the target block is decoded based on the variable length coding table shown in table (803).

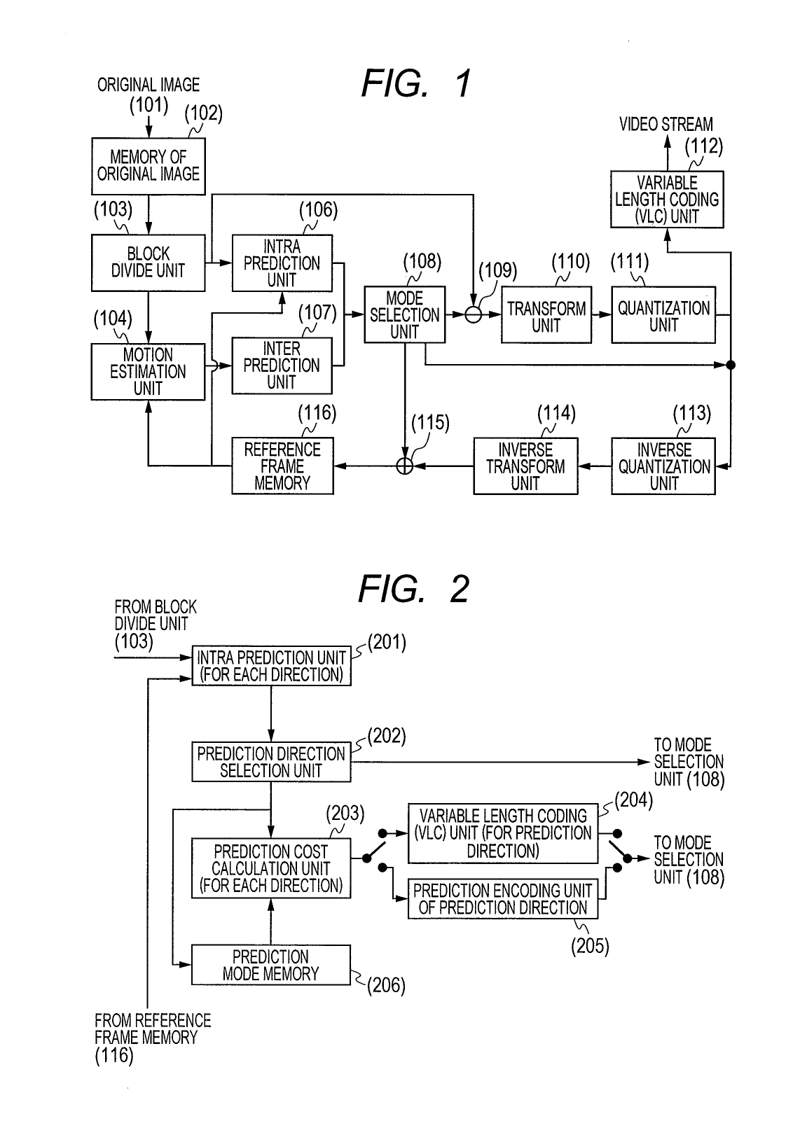

A moving picture encoding device according to the present embodiment will next be explained using FIG. 1.

The moving picture encoding device according to the present embodiment includes an input image memory (102) which holds an input original image (101), a block divide unit (103) which divides the input image into small areas, a motion estimation unit (104) which detects motion in block units, an intra prediction unit (106) which performs an intra prediction process (described in FIG. 7) in block units in like manner, an inter prediction unit (107) which performs inter prediction in block units based the amount of motion detected by the motion estimation unit (104), a mode selection unit (108) which selects a prediction encoding means corresponding to the property of an image, a subtraction unit (109) which generates residual data, a transform unit (110) and a quantization unit (111) which perform encoding to the residual data, a variable length coding unit (112) which performs encoding corresponding to the probability of occurrence of each sign, an inverse quantization unit (113) and an inverse transform unit (114) which decode the encoded residual data, an addition unit (115) which generates a decoded image using the decoded residual data, and a reference frame memory (116) which stores the decoded image therein.

The input image memory (102) retains a single image of the original image (101) as a target image or frame for encoding. The block divide unit (103) divides the image into small blocks and outputs the divided images to the motion estimation unit (104) and the intra prediction unit (106). The motion estimation unit (104) calculates the amount of motion of the corresponding block using the decoded image stored in the reference frame memory (116) and outputs the amount of motion to the inter prediction unit (107) as motion vector data. The intra prediction unit (106) and the inter prediction unit (107) perform an intra prediction process and an inter prediction process in block units. The mode selection unit (108) selects the optimal prediction process out of the intra prediction process and the inter prediction process. The mode selection unit (108) outputs a predicted image about the selected prediction process to the subtraction unit (109). When the intra prediction process is selected here, the mode selection unit (108) outputs encoded prediction direction data to be described later to the variable length decoding unit (112). The subtraction unit (109) generates residual data between the input image and the predicted image based on the optical prediction encoding process and outputs the residual data to the transform unit (110). The transform unit (110) and the quantization unit (111) perform transformation such as DCT (Discrete Cosine Transformation) and quantization processing to the transmitted residual data respectively in block units of a designated size and output the transformed data to the variable length coding unit (112) and the inverse quantization unit (113). The variable length coding unit (112) performs variable length coding to residual information expressed by transform coefficients, based on the probability of occurrence of signs along with information necessary for prediction decoding, such as prediction directions at intra prediction encoding and moving vectors at inter prediction encoding, etc., to thereby generate a coded video stream. The inverse quantization unit (113) and the inverse transform unit (114) perform inverse quantization and inverse transformation such as IDCT (Inverse DCT) to the post-quantization transform coefficients to obtain a residual and output the transformed data to the addition unit (115). The addition unit (115) generates a decoded image and outputs the decoded image to the reference frame memory (116). The reference frame memory (116) stores the decoded image therein.

FIG. 2 is a diagram showing the details of the intra prediction unit (106) of the moving picture encoding device according to the present embodiment.

Here, for example, each of the images divided by the block divide unit (103) shown in FIG. 1 is inputted to the intra prediction unit (106). The input image is inputted to a direction-specific prediction unit (201). The direction-specific prediction unit (201) generates predicted images about respective prediction directions using the pixel values of the decoded images of the encoded adjacent blocks, stored in the reference frame memory and performs a prediction process to the blocks of the input images inputted from the block divide unit (103). The encoding method based on H.264/AVC described in FIG. 5 is used in the present encoding process. This result of prediction is inputted to a prediction direction determination unit (202). As the result of prediction, there are considered a difference between the block of the input image and the predicted image, the predicted image itself, etc. The prediction direction determination unit (202) selects a prediction direction best in coding efficiency and determines the prediction direction as a prediction direction of a target block for encoding. Here, the prediction direction determination unit (202) outputs a predicted image about the determined prediction direction to the mode selection unit (108). Further, the prediction direction determination unit (202) outputs information about the determined prediction direction to a prediction cost calculation unit (203). A prediction direction memory (206) stores the determined prediction memory therein. The prediction direction cost calculation unit (203) reads prediction direction information of each peripheral encoded block from the prediction direction memory (206) and determines from the read prediction direction information whether it is easy to estimate the prediction direction of the block to be encoded. As this determination method, for example, the method described in FIG. 8 may be used. A prediction direction encoding method is switched based on the result of determination.

When the estimation of the prediction direction of the block to be encoded is determined to be easy, for example, the encoding of prediction direction data is performed by a prediction direction prediction encoding unit (205). The prediction direction prediction encoding unit (205) performs the encoding of the prediction direction data using the method (prediction direction encoding method A) of FIG. 8 (802), for example.

On the other hand, when the estimation of the prediction direction of the block to be encoded is determined not to be easy, the encoding of prediction direction data is performed by a prediction direction variable-length encoding unit (204). The prediction direction variable length encoding unit (204) performs the encoding of a prediction direction using the method (prediction direction encoding method B) of FIG. 8 (803), for example.

The prediction direction variable-length encoding unit (204) or the prediction direction prediction encoding unit (205) output the prediction direction data encoded in the above-described manner to the mode selection unit (108). Incidentally, although the encoding of the prediction direction data has been carried out by the intra prediction unit (106) in the example of FIG. 2, this encoding process can also be performed by the variable length encoding unit (112) or may be performed by another component part.

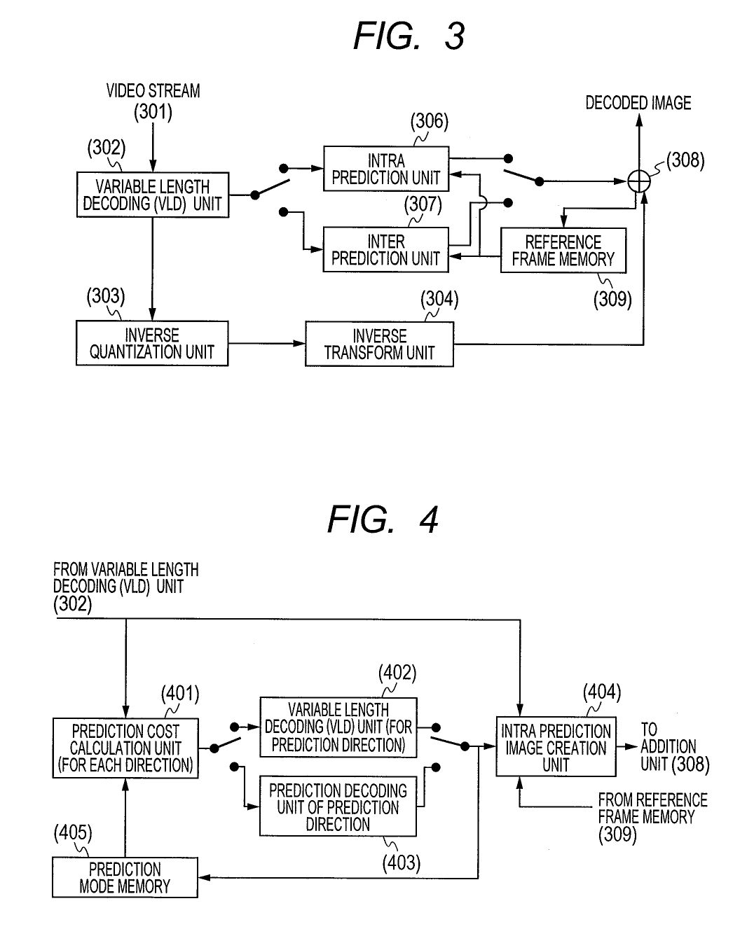

One example of a moving picture decoding device according to the present embodiment will next be explained using FIG. 3. The moving picture decoding device according to the present embodiment includes, for example, a variable length decoding unit (302) which performs a procedure opposite to the variable length encoding to a coded video stream (301) generated by the moving picture encoding device shown in FIG. 1, an inverse quantization unit (303) and an inverse transform unit (304) which decode residual data, an intra prediction unit (306) which performs an intra prediction process, an inter prediction unit (307) which performs inter prediction, an addition unit (308) which generates a decoded image, and a reference frame memory (309) which stores the decoded image therein.

The variable length decoding unit (302) variable-length decodes the video stream (301) to obtain information necessary for a prediction process, such as a residual transform coefficient component, a prediction direction, motion vectors, etc. The residual transform coefficient component is outputted to the inverse quantization unit (303). The prediction direction, the motion vectors and so on are outputted to the intra prediction unit (306) or the inter prediction unit (307) according to predicting means. Subsequently, the inverse quantization unit (303) and the inverse transform unit (304) perform inverse quantization and inverse transformation to the residual information respectively to decode the residual data. The intra prediction unit (306) and the inter prediction unit (307) perform a prediction process based on the data inputted from the variable length decoding unit (302), referring to the decoded image stored in the reference frame memory (309). The addition unit (308) generates a decoded image. The reference frame memory (309) stores the decoded image therein.

FIG. 4 is a diagram showing the details of the intra prediction unit (306) of the moving picture decoding device according to the present embodiment.

Here, a prediction direction cost calculation unit (401) reads prediction direction information of each peripheral decoded block from a prediction direction memory (405) and determines based on the read information whether it is easy to estimate the prediction direction of a block to be decoded. As this determination method, for example, the method described in FIG. 8 may be used. The prediction direction cost calculation unit (401) performs switching of a destination to which prediction direction data of the block to be decoded inputted from the variable length decoding unit (302) is outputted, based on the result of determination. That is, a decoding method is switched.

For example, when it is determined that the estimation of the prediction direction of the block to be decoded is easy, the decoding of prediction direction data is performed by a prediction direction prediction decoding unit (403). The prediction direction prediction decoding unit (403) performs a decoding process of prediction direction data using a decoding method corresponding to the method (prediction direction encoding method A) of FIG. 8 (802), for example.

On the other hand, when the estimation of the prediction direction of the block to be decoded is determined not to be easy, the decoding process of prediction direction data is performed by a prediction direction variable length decoding unit (402). The prediction direction variable length decoding unit (402) performs the decoding process of a prediction direction using a decoding method corresponding to the method (prediction direction encoding method B) of FIG. 8 (803), for example.

The prediction direction data subjected to the decoding process as described above is inputted to an inter prediction image creation unit (404). Further, the prediction direction data subjected to the decoding process is stored in the prediction direction memory (405). The inter prediction image creation unit (404) outputs an intra prediction image to the addition unit (308) based on the pixel value of the decoded image of each adjacent block inputted from the reference frame memory (309) and the prediction direction data subjected to the decoding process.

Incidentally, although the decoding process of the prediction direction data is carried out at the intra prediction unit (306) in the example of FIG. 4, the present decoding process can also be performed by the variable length decoding unit (302) or may be carried out by another component part.

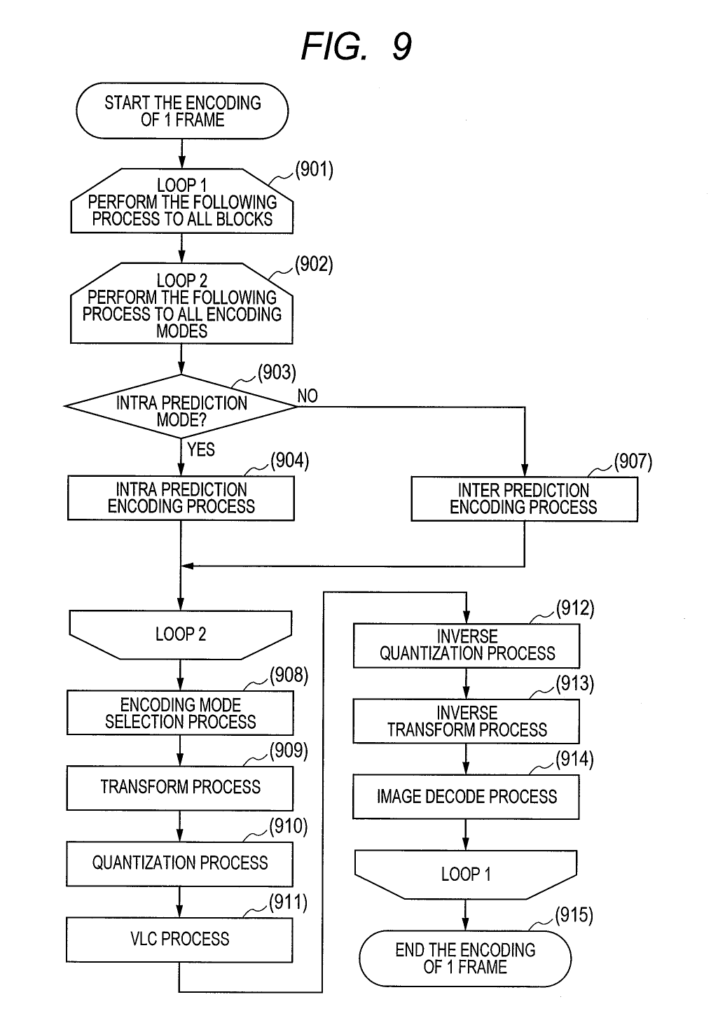

A procedure for the encoding of one frame in the moving picture encoding device according to the present embodiment will next be explained using FIG. 9.

The following processes are performed to all blocks existing in frames to be encoded (901). That is, a prediction encoding process is once performed to all encoding directions (combination of prediction method and block size) in association with the blocks to thereby calculate residuals and select the encoding direction highest in coding efficiency.

Upon the prediction encoding process, an intra prediction encoding process (904) or an inter prediction encoding process (907) is performed to select the optimal prediction encoding process, thereby performing encoding efficiently depending on the property of an image.

When the encoding direction best in coding efficiency is selected out of the many encoding directions (908), for example, the RD-Optimization method for determining the optimal encoding direction from the relationship between the image-quality distortion and the amount of coding is used, whereby the encoding can be performed efficiently. The details of the RD-Optimization method are described in a Reference Literature 1.

### REFERENCE LITERATURE 1

G. Sullivan and T. Wiegand: “Rate-Distortion Optimization for Video Compression”, IEEE Signal Processing Magazine, vol. 15, no. 6, pp. 74-90, 1998.

Subsequently, transformation (909) and a quantization process (910) are performed to residual data generated based on the selected encoding direction. Further, variable length encoding is performed to generate a video stream (911).

On the other hand, an inverse quantization process (912) and an inverse transform process (913) are performed to quantized transform coefficients to decode the residual data, whereby a decoded image is generated and stored in the reference frame memory (914). If the above processing is completed with respect to all the blocks, the encoding of an image of one frame is ended (915).

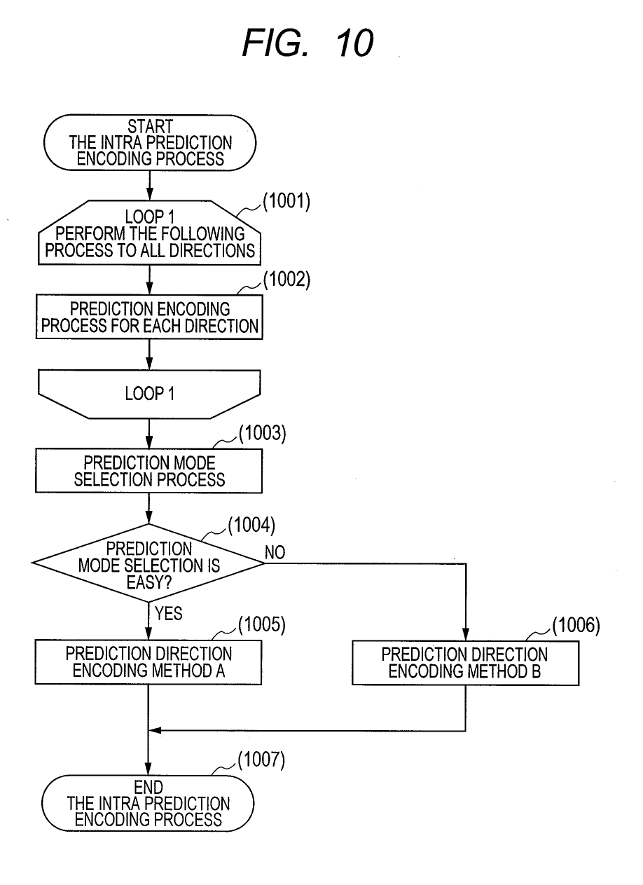

The details of a procedure for the intra prediction encoding process (904) of FIG. 9 will next be explained using FIG. 10.

An intra prediction process (1002) is performed to all prediction directions (1001) at each block to be encoded. The optimal prediction direction is selected out of all the prediction directions (1003). It is determined from information on encoded peripheral blocks whether it is easy to estimate the prediction direction (1004). If it is easy to estimate it, encoding is performed using the prediction direction encoding method A (1005). If it is not easy to estimate it, encoding is performed using the prediction direction encoding method B (1006), whereby the encoding of each prediction direction corresponding to one block is ended (1007).

Incidentally, although the encoding of the prediction direction data has been carried out in the intra prediction encoding process (904) in the example of FIG. 10, this encoding can also be performed in the variable length encoding process (911) or may be performed within another process.

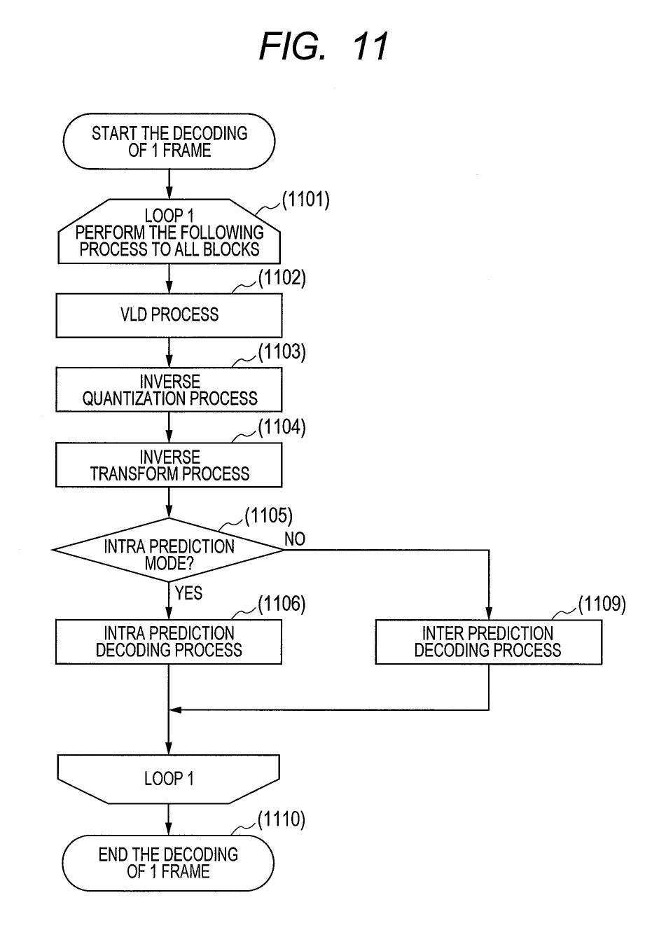

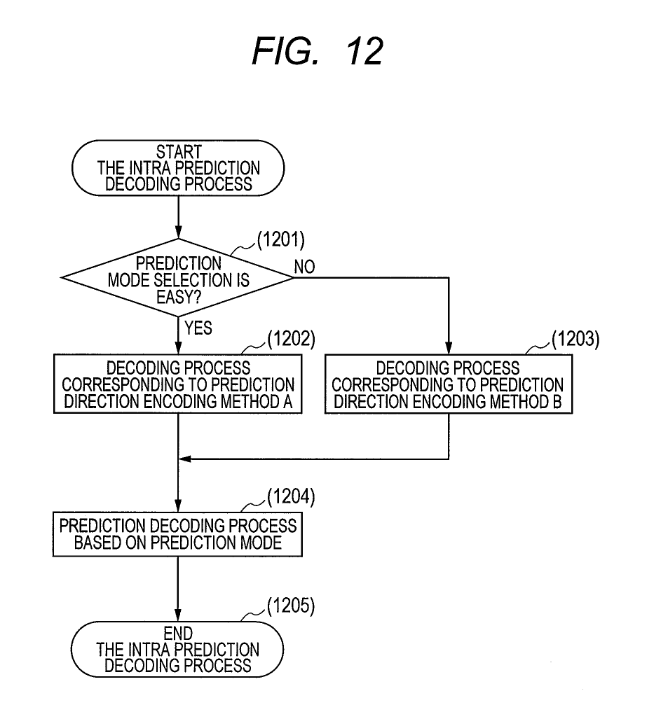

A procedure for the decoding of one frame in the moving picture decoding device shown in FIG. 3 will next be explained using FIG. 11.

The following processes are first performed to all blocks in one frame (1101). That is, a variable length decoding process is performed to an input stream (1102). An inverse quantization process (1103) and an inverse transform process (1104) are performed, whereby residual data is decoded. Subsequently, a prediction mode in which a target block is being prediction-encoded, is determined based on information included in the video stream. An intra prediction decoding process (1106) or an inter prediction decoding process (1109) is performed based on the result of determination to generate a predicted image. The predicted image is added to the decoded residual data to create a decoded image. The created decoded image is stored in the reference frame memory. If the above processing is completed with respect to all the blocks in the frame, the decoding of an image of one frame is ended (1110).

The details of a procedure for the intra prediction decoding process (1106) of FIG. 11 will next be explained using FIG. 12.

From prediction directions of decoded blocks located around a target block, a determination is first made whether the estimation of a prediction direction of the target block is easy (1201). If the estimation of the prediction direction of the target block is easy at this time, decoding corresponding to the prediction direction encoding method A is executed (1202). If not so, a decoding process corresponding to the prediction direction encoding method B is executed (1203). If a prediction decoding process is performed based on the finally-decoded prediction direction data (1204), the intra prediction decoding process corresponding to one block is ended (1205).

Incidentally, although the decoding of the prediction direction data has been carried out in the intra prediction decoding process (1106) in the example of FIG. 12, this decoding can also be performed in the variable length decoding process (1102) or may be performed within another process.

Although DCT has been taken as one example of the transformation in the present embodiment, any of DST (Discrete Sine Transformation), WT (Wavelet Transformation), DFT (Discrete Fourier Transformation), KLT (Karhunen-Loeve Transformation), etc. may be adopted if it takes transform used in the elimination of an inter-pixel correlation.

In particular, coding may be performed to a residual itself without performing transformation. Further, the variable length coding may not be performed in particular

Although the present embodiment has described the case where prediction is performed in the block units of the 4×4 pixel size in particular, the present invention may be applied to blocks having any of a 8×8 pixel size, a 16×16 pixel size, etc., for example.

Although prediction is performed along the eight directions defined in H.264/AVC in the present embodiment, the number of directions may be increased or decreased.

According to the moving picture encoding device, moving picture encoding method, moving picture decoding device and moving picture decoding method according to the embodiment 1 described above, the amount of code can be more reduced in the encoding/decoding process of the moving picture.

### Embodiment 2

The embodiment 2 will explain an example in which such a selective encoding process as described in the embodiment 1 is used in the encoding process of prediction mode information such as the size of a macro block and prediction methods (intra prediction and inter prediction), etc. used in prediction encoding.

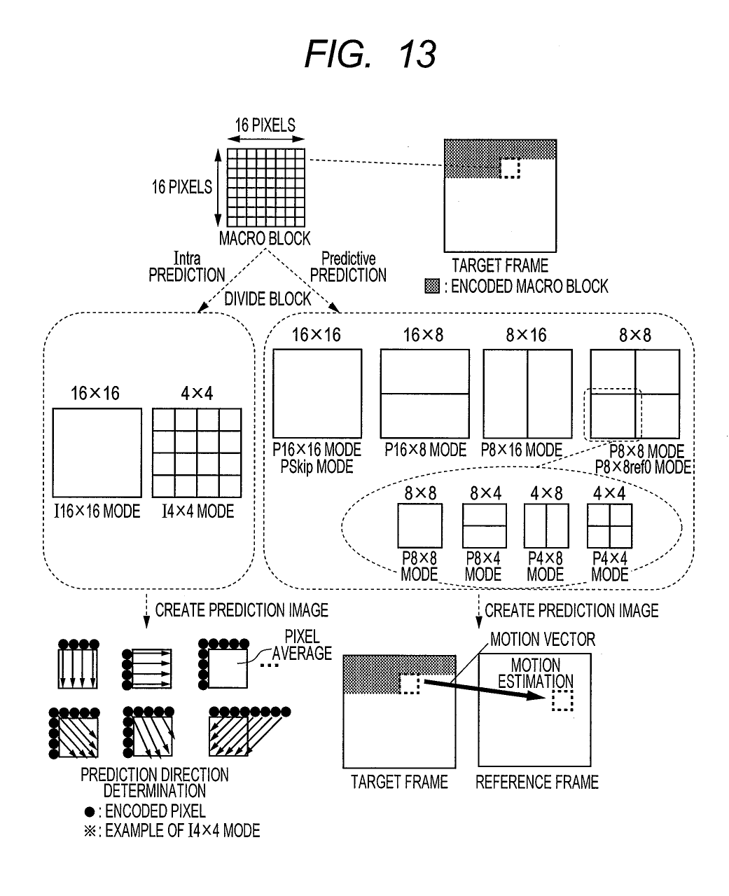

FIG. 13 shows the type of encoding mode available in a Baseline profile under H.264/AVC. In H.264/AVC, an encoding mode is determined for every macro block whose size is 16×16 pixels. Here, the size of each block to which either one of the prediction methods corresponding to the intra prediction that performs compression using a pixel correlation between intra blocks or the inter prediction using a pixel correlation between inter blocks is applied, and which is used in prediction, is determined. In H.264/AVC, forward direction (Predictive prediction) for designating or specifying a single reference frame, and bi-directional prediction (Bi-directional predictive prediction) capable of specifying two reference frames are defined as inter pixel value prediction methods, but only the Predictive prediction is available where the Baseline profile is used.

In each frame, encoding is sequentially performed from a macro block placed in the upper left corner of a screen to a macro block placed in the lower right corner thereof in accordance with raster scan order. The macro block can be divided into blocks each having a smaller size. The optimal one is selected out of several sizes defined for every type of prediction method in advance and encoded. In the case of the intra prediction, two types of block sizes of 16×16 pixels (I16×16 mode) and 4×4 pixels (I14×4 mode) can be used. Either a suitable one of the two modes is used. On the other hand, sizes of 16×16 pixels (P16×16 mode), 16×8 pixels (P16×8 mode), 8×16 pixels (P8×16 mode), and 8×8 pixels (P8×8 mode) are prepared for the inter prediction. The 8×8 pixel size can be further divided into submacro blocks of 8×8 pixel, 8×4 pixel, 4×8 pixel and 4×4 pixel sizes. Further, a PSkip mode in which motion vector information is not encoded is prepared for the block size of 16×16 pixels, whereas a P8×8ref0 mode in which a reference frame number is not encoded is prepared for the 8×8 pixel size.

The above-described prediction methods and block sizes are determined with respect to the respective macro blocks, and their information is encoded. The combinations (e.g., I16×16 mode, I4×4 mode and the like) of the prediction methods (intra prediction and inter prediction) and the block sizes illustrated in the above are called block type.

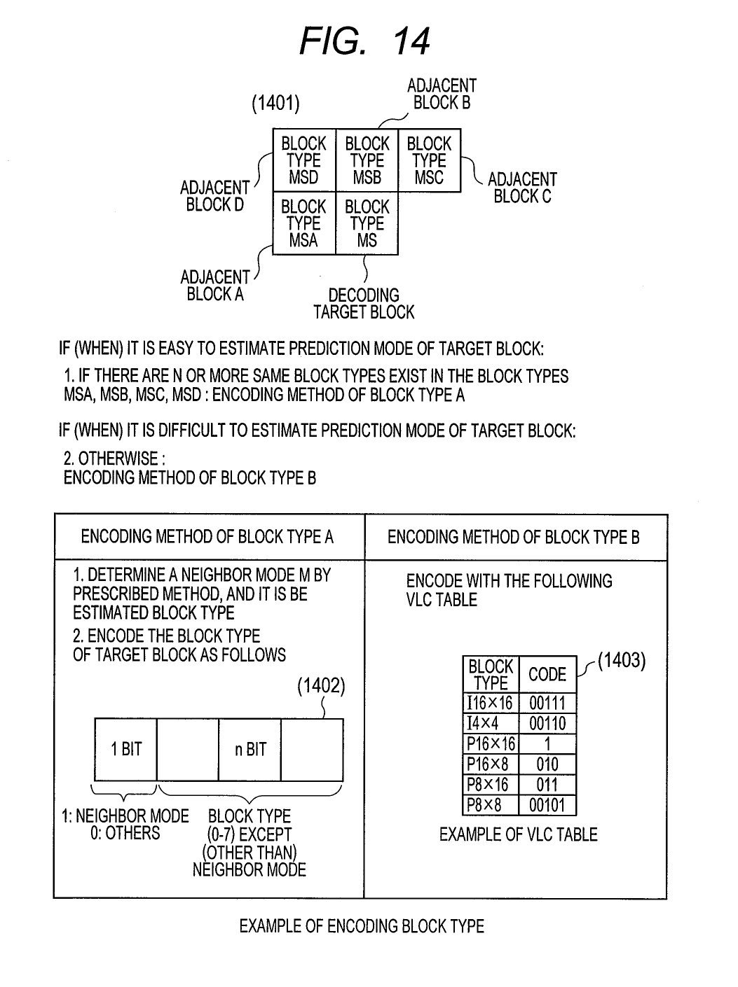

A block type encoding method according to the present embodiment will now be explained using FIG. 14. An image block explanatory diagram (1401), a bit pattern diagram (1402), and a variable length coding table (1403) in FIG. 14 respectively correspond to the image block explanatory diagram (801), bit pattern diagram (802) and variable length coding table (803) in FIG. 8 of the embodiment 1.

As is apparent if FIG. 14 (embodiment 2) and FIG. 8 (embodiment 1) are compared with each other, the difference between the two resides in that the encoding method of block type shown in FIG. 14 can be achieved if the “prediction direction” of FIG. 8 is changed to the “block type”.

Specifically, as shown in the image block explanatory diagram (1401), a block type of a target block is estimated using decoded images of encoded adjacent blocks A, B, C and D respectively adjacent to the left, upper, upper left and upper right sides with respect to the target block. At this time, the encoding method of block type is switched depending on whether the estimation of the block type is easy. When the estimation of the block type is easy, a block type encoding method A is used, and the block type of the target block is encoded based on the result of prediction using the block type of each adjacent block. On the other hand, when the estimation of the block type is not easy, a block type encoding method B is used, and the block type is singly encoded without being estimated from each adjacent block. This determination of estimation difficulty level can be performed by, for example, a method such as the assumption that a majority decision is made from block types MSA, MSB, MSC and MSD of peripheral encoded adjacent blocks A, B, C and D, and when there are N (where N: integer greater than or equal to 2) or more same block types exist, the estimation of the block type is easy, whereas the estimation thereof is not easy at other than it.

The bit pattern diagram (1402) shows the details of a bit pattern indicative of a prediction method at the block type encoding method A. The block type encoding method A needs to decide an adjacent mode (estimated block type). This can however be determined by, for example, a method such as the assumption of the block type that appears most often, of the block types of peripheral blocks as an adjacent mode (estimated block type).

The table (1403) shows one example of a variable length coding table used in the block type encoding method B. The block type encoding method B variable-length encodes a block type in accordance with such a variable length coding table as designated at (1403). The variable length coding table like the table (1403) is one example, and another pattern may be used.

While the encoding has been described above, decoding can be performed by carrying out a process opposite to the corresponding encoding method upon decoding.

That is, the estimation difficulty level of a block type of a target block is determined using block type information on each adjacent decoded block. When the estimation of the block type is easy, the decoding of the block type is performed in accordance with the bit pattern of the bit pattern diagram (1402). On the other hand, when the estimation of the block type is not easy, the decoding of the block type is conducted based on the coding table like the table (1403), so that the corresponding block type can be decoded.

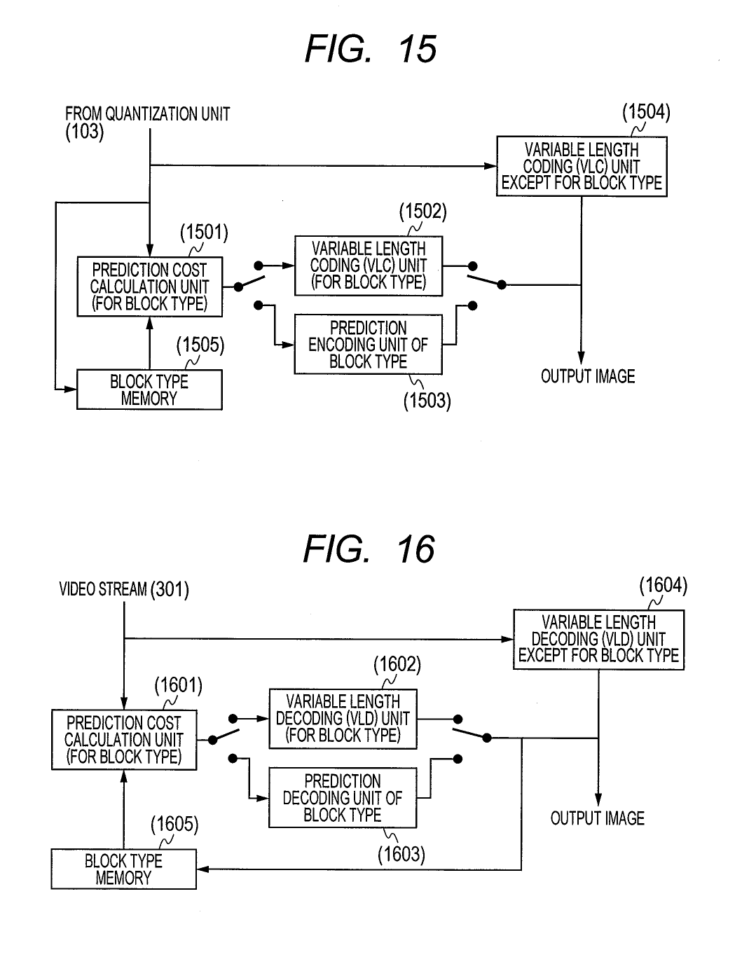

An image encoding device according to the present embodiment can be achieved if the variable length coding unit (112) is taken as a configuration shown in FIG. 15 in the image encoding device of FIG. 1 showing the embodiment 1. Since the present image encoding device is identical in other configuration to that of FIG. 1 showing the embodiment 1, the description thereof is omitted.

In FIG. 15, the variable length coding unit (112) is inputted with data quantized by the quantization unit (103) shown in FIG. 1, for example. Block type information of the input data is stored in a block type memory (1505). A block type cost calculation unit (1501) reads information of each peripheral encoded block type from the block type memory (1505) and determines the estimation difficulty level of a block type of a target block, based on the read information. The determination of the estimation difficulty level can use the method described in FIG. 14, for example. A block type encoding method is switched based on this determination.

For example, when the estimation of the block type is determined to be easy, the encoding of the block type is performed by a block type prediction encoding unit (1503). The block type prediction encoding unit (1503) performs the encoding of the block type using the method (block type encoding method A) shown in the bit pattern diagram (1402) of FIG. 14.

For example, when the estimation of the block type is determined not to be easy, the encoding of the block type is carried out by a block type variable length coding unit (1502). The block type variable length coding unit (1502) performs the encoding of the block type using a variable length coding method (block type encoding method B) that uses the table (1403) of FIG. 14, for example.

As described above, encoding is performed while selecting the method of encoding the block type every block.

At the same time, a variable length coding unit (1504) except for the block type performs variable length coding of data other than the block type and sets this result and the result of encoding of the block type as output values. Although the encoding of the block type is performed by the variable length coding unit (112) in the example of FIG. 15, the encoding can also be performed by the mode selection unit (108) or may be done by another component part.

An image decoding device according to the present embodiment can be achieved if the variable length decoding unit (302) is taken as a configuration shown in FIG. 16 in the image decoding device of FIG. 3 showing the embodiment 1. Since the present image decoding device is identical in other configuration to that of FIG. 3 showing the embodiment 1, the description thereof is omitted.

In FIG. 16, a block type cost calculation unit (1601) reads information of a block type of each peripheral decoded block from a block type memory (1605) and determines the estimation difficulty level of a block type of a target block, based on the read information. This method is able to use the method described in FIG. 14, for example. A block type decoding method is switched based on this determination.

For example, when the estimation of the block type is determined to be easy, the decoding of the block type is performed by a block type prediction decoding unit (1603). The block type prediction decoding unit (1603) performs decoding using a decoding method corresponding to the method (block type encoding method A) shown in the bit pattern diagram (1402) of FIG. 14, for example.

When the estimation of the block type is determined not to be easy, the decoding of the block type is carried out by a block type variable length decoding unit (1602). The block type variable length decoding unit (1602) performs the decoding of the block type using a decoding method corresponding to a variable length decoding method (block type encoding method B) that uses the table (1403) of FIG. 14, for example.

Each block type decoded as described above is stored in the block type memory (1605).

A variable length decoding unit (1604) except for the block type performs variable length decoding of data other than the block type and outputs the result of decoding of the data other than the block type and the result of decoding of each block type.

Although the decoding of the block type is performed by the variable length decoding unit (302) in the example of FIG. 16, the decoding can also be performed by the intra prediction unit (306) and the inter prediction unit (307) or may be done by another component part.

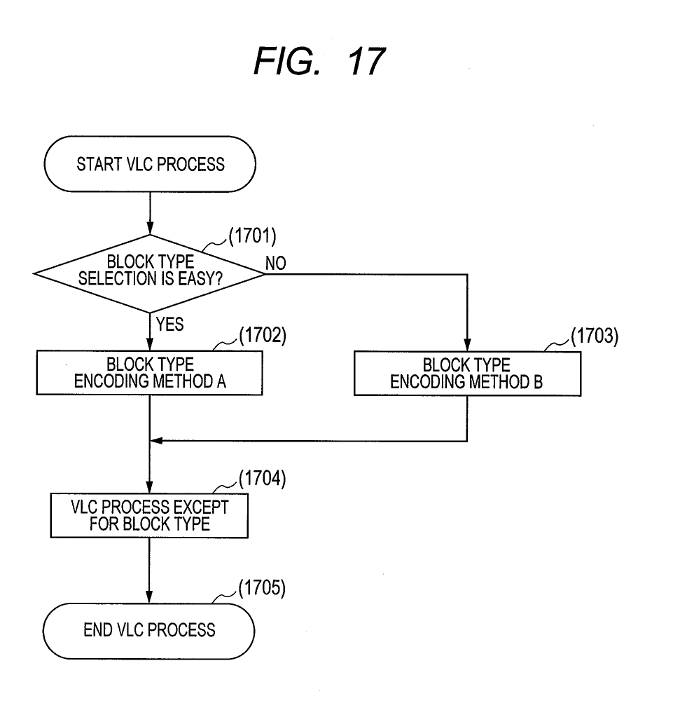

In the procedure for the encoding of one frame in the moving picture encoding device according to the present embodiment, the details of the variable length encoding process (911) of FIG. 9 in the embodiment 1 may take the contents shown in FIG. 17. Since other processes are similar to the embodiment 1, the description thereof is omitted.

In FIG. 17, it is first determined from information about each encoded peripheral block whether it is easy to estimate a block type of a block to be encoded (1701). If it is easy to estimate it, encoding is carried out using the corresponding block type encoding method A (1702). If not so, the encoding is performed using the corresponding block type encoding method B (1703). Finally, a variable length encoding process other than the block type is carried out (1704), and variable length encoding of one block is ended (1705).

Although the encoding of the block type is performed in the variable length encoding process (911) in the example of FIG. 17, this encoding can also be done in the encoding mode selection process (908) or may be carried out within another process.

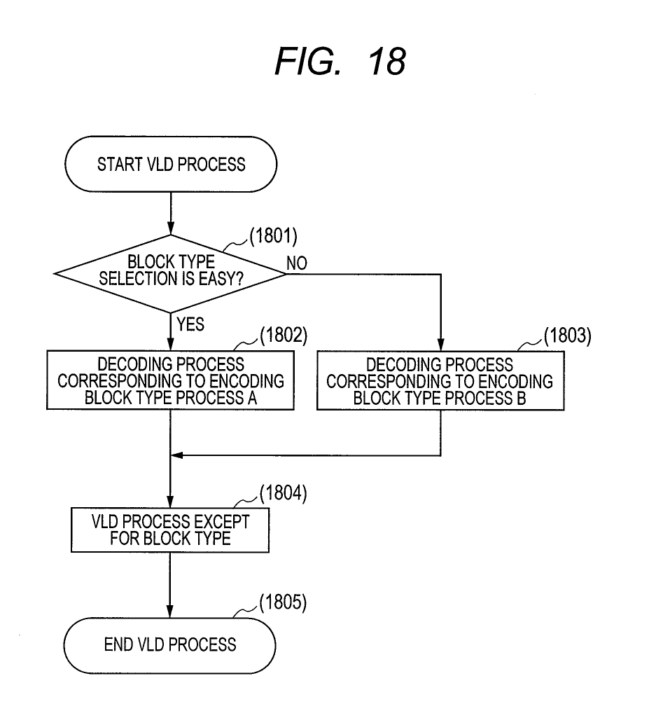

In the procedure for the decoding of one frame in the moving picture decoding device according to the present embodiment, the details of the variable length decoding process (1102) of FIG. 11 in the embodiment 1 may take the contents shown in FIG. 18. Since other processes are similar to the embodiment 1, the description thereof is omitted.

In FIG. 18, it is first determined from information about each decoded peripheral block whether it is easy to estimate a block type of a block to be decoded (1801). If it is easy to estimate it, decoding is carried out using a decoding method corresponding to the block type encoding method A (1802). If not so, the decoding is performed using a decoding method corresponding to the block type encoding method B (1803). Finally, a variable length decoding process except for the block type is carried out (1804), and variable length encoding of one block is ended (1805).

Although the decoding of the block type is performed in the variable length decoding process (1102) in the example of FIG. 18, this decoding can also be done in the intra prediction decoding process (1106) and the intra prediction decoding process (1109), or may be carried out within another process.

Although DCT has been taken as one example of the transformation in the present embodiment, any of DST (Discrete Sine Transformation), WT (Wavelet Transformation), DFT (Discrete Fourier Transformation), KLT (Karhunen-Loeve Transformation), etc. may be adopted if it takes transform used in the elimination of an inter-pixel correlation. In particular, coding may be performed to a residual itself without performing transformation.

Further, the variable length coding may not be performed in particular. Although the prediction is performed along the eight directions defined in H.264/AVC in the present embodiment, the number of directions may be increased or decreased.

Although the example illustrative of some block types is taken in the present embodiment, other block types may be used.

Although the above two embodiments respectively have shown the example in which the present invention is applied to the encoding and decoding of each prediction direction at the intra prediction, and the encoding and decoding of each block type at the prediction encoding, the present invention can be applied even in the case of other information such as CBP (Coded Block Pattern) indicative of the presence or absence of a frequency coefficient, motion vectors and the like if the encoding and decoding of information necessary to be encoded in block units are taken.

### INDUSTRIAL APPLICABILITY

The present invention is useful as a moving picture encoding technique for encoding a moving picture and a moving picture decoding technique for decoding a moving picture.

### REFERENCE SIGNS LIST

101 . . . original image, 102 . . . memory of original image, 103 . . . block divide unit, 104 . . . motion estimation unit, 106 . . . intra prediction unit, 107 . . . inter prediction unit, 108 . . . direction selection unit, 109 . . . subtraction unit, 110 . . . transform unit, 111 . . . quantization unit, 112 . . . variable length coding unit, 113 . . . inverse quantization unit, 114 . . . inverse transform unit, 115 . . . addition unit, 116 . . . reference frame memory, 201 . . . direction-specific prediction unit, 202 . . . prediction direction determination unit, 203 . . . prediction direction estimation cost calculation unit, 204 . . . prediction direction variable-length encoding unit, 205 . . . prediction direction prediction encoding unit, 206 . . . prediction direction memory, 207 . . . inter prediction image creation unit, 301 . . . video stream, 302 . . . variable length decoding unit, 303 . . . inverse quantization unit, 304 . . . inverse transform unit, 306 . . . intra prediction unit, 307 . . . inter prediction unit, 308 . . . addition unit, 309 . . . reference frame memory, 401 . . . prediction direction cost calculation unit, 402 . . . prediction direction variable-length decoding unit, 403 . . . prediction direction prediction decoding unit, 404 . . . inter prediction image creation unit, 405 . . . prediction direction memory, 1501 . . . block type cost calculation unit, 1502 . . . block type adjustable coding unit, 1503 . . . block type prediction encoding unit, 1504 . . . variable length coding unit for block type, 1505 . . . bloc type memory, 1601 . . . block type cost calculation unit, 1602 . . . block type adjustable decoding unit, 1603 . . . block type prediction decoding unit, 1604 . . . variable length decoding unit for block type, 1605 . . . block type memory.

1. A moving picture decoding method for performing an intra prediction process, comprising:
a determination step for determining the number of blocks each having the same prediction direction or the same block size, of a plurality of decoded adjacent blocks adjacent to a block to be decoded;
a decoding step for decoding prediction direction data or block size data of the block to be decoded, based on a result of the determination of the determination step; and
a creation step for performing intra prediction, based on the prediction direction data or the block size data decoded in the decoding step and generating decoded image data.

2. The moving picture decoding method according to claim 1, wherein when two or more blocks each having the same prediction direction or the same block size exist within the adjacent blocks in the determination step, the prediction direction or the block size is assumed to be an estimated prediction direction of the block to be decoded or an estimated block size thereof, and
wherein in the decoding step, the prediction direction data of the block to be decoded or the block size data thereof is decoded based on bit pattern information generated based on the estimated prediction direction data or the estimated block size and included in a coded stream.

3. The moving picture decoding method according to claim 1, wherein when the two or more blocks each having the same prediction direction data or the same block size do not exist in the adjacent blocks in the determination step, the prediction direction data of the block to be decoded or the block size data thereof is decoded by a variable length decoding process in the decoding step.

4-6. (canceled)

7. A moving picture decoding device for performing an intra prediction process, comprising:
a determination unit that determines the number of blocks each having the same prediction direction or the same block size, of a plurality of decoded adjacent blocks adjacent to a block to be decoded;
a decoding unit that decodes prediction direction data or block size data of the block to be decoded, based on a result of the determination by the determination unit; and
an decoded image creation unit that performs intra prediction, based on the prediction direction data or the block size data decoded at the decoding unit and generates a decoded image.

8. The moving picture decoding device according to claim 7, wherein when the determination unit determines that two or more blocks each having the same prediction direction or the same block size exist within the adjacent blocks, the determination unit assumes the prediction direction or the block size to be an estimated prediction direction of the block to be decoded or an estimated block size thereof, and
wherein the decoding unit decodes the prediction direction data of the block to be decoded or the block size data thereof, based on bit pattern information generated based on the estimated prediction direction data or the estimated block size and included in a coded stream.

9. The moving picture decoding device according to claim 7, wherein when the determination unit determines that the two or more blocks each having the same prediction direction data or the same block size do not exist in the adjacent blocks, the decoding unit decodes the prediction direction data of the block to be decoded or the block size data thereof by a variable length decoding process.

10-12. (canceled)
